(19) United States
(12) Patent Application Publication
(10) Pub. No.: US 2022/0406281 A1
(43) Pub. Date: Dec. 22, 2022

(54) ELECTRONIC MUSICAL INSTRUMENTS, METHOD AND STORAGE MEDIA THEREFOR

(71) Applicant: CASIO COMPUTER CO., LTD., Tokyo (JP)

(72) Inventors: Hiroki SATO, Tokyo (JP); Hajime KAWASHIMA, Tokyo (JP)

(73) Assignee: CASIO COMPUTER CO., LTD., Tokyo (JP)

(21) Appl. No.: 17/751,595

(22) Filed: May 23, 2022

(30) Foreign Application Priority Data
Jun. 17, 2021 (JP) 2021-100633

(51) Int. Cl. G10H 1/057; G10H 7/02; G10H 1/08

(52) U.S. Cl. CPC G10H 1/0575; G10H 7/02; G10H 1/08

(57) ABSTRACT

An electronic musical instrument comprises: a performance controller; and at least one processor, configured to perform the following: instructing sound generation of a first musical tone in response to a first operation on the performance controller; in response to a second operation on the performance controller during the sound generation of the first musical tone, obtaining a first amplitude value of the first musical tone at a time of the second operation, and obtaining a second amplitude value at which a second musical tone is to be sound-produced in response to the second operation on the performance controller; determining a parameter value for adjusting a decay rate of the first musical tone based on a ratio of the first amplitude value to the second amplitude value; and causing the first musical tone to decay based on the determined parameter value.

### BACKGROUND OF THE INVENTION

### Technical Field

The disclosure herein relates to electronic musical instruments, methods and storage media therefor.

### Background Art

In an electronic musical instrument, a technique has been known in which when an operation of repeatedly producing a musical tone for a performance operator having a single pitch (hereinafter referred to as “rapid reiteration operation”) is performed, a musical sound in response to the latest new key press operation is produced while at the same time a musical sound that has already been produced in response to previous key press operations is quickly attenuated. For example, Japanese Patent Application Laid-Open No. 2001-209382 describes a specific configuration of an electronic musical instrument to which such a technique is applied.

However, in order to remove the audible unnaturalness of the musical sound produced during rapid reiteration operations by muting the small musical sound early, if the velocity at the time of the latest key press is higher than the velocity of the previous key press, the musical sound produced in response to the previous key press operation is attenuated at twice the normal speed.

Also, if the velocity of the latest key press is the same as or smaller than the velocity of the previous key press, the musical sound corresponding to the previous key press operation is attenuated at the normal speed.

For example, when a key pressing operation with a high velocity is repeatedly performed, if the velocity of the current key pressing is the same as or smaller than the velocity of the previous key press, the musical sound generated in response to the previous key press operation is attenuated at the normal speed. Therefore, when the rapid reiteration operation is repeated, the musical tone that could not be completely attenuated at the normal speed remains at a level that is not small, and the volume may increase unnaturally although it is temporary.

### SUMMARY OF THE INVENTION

It is desired to further improve an electronic musical instrument in order to bring the musical sound during the rapid reiteration operation closer to the natural musical sound.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an electronic musical instrument that comprises: a performance controller; and at least one processor, configured to perform the following: instructing sound generation of a first musical tone in response to a first operation on the performance controller; in response to a second operation on the performance controller during the sound generation of the first musical tone, obtaining a first amplitude value of the first musical tone at a time of the second operation, and obtaining a second amplitude value at which a second musical tone is to be sound-produced in response to the second operation on the performance controller; determining a parameter value for adjusting a decay rate of the first musical tone based on a ratio of the first amplitude value to the second amplitude value; and causing the first musical tone to decay based on the determined parameter value.

In another aspect, the present disclosure provides a method executed by at least one processor in an electronic musical instrument that includes, in addition to the at least one processor, a performance controller, the method comprising, via the at least one processor: instructing sound generation of a first musical tone in response to a first operation on the performance controller; in response to a second operation on the performance controller during the sound generation of the first musical tone, obtaining a first amplitude value of the first musical tone at a time of the second operation, and obtaining a second amplitude value at which a second musical tone is to be sound-produced in response to the second operation on the performance controller; determining a parameter value for adjusting a decay rate of the first musical tone based on a ratio of the first amplitude value to the second amplitude value; and causing the first musical tone to decay based on the determined parameter value.

In another aspect, the present disclosure provides a computer readable non-transitory storage medium storing therein instructions, the instructions causing at least one processor in an electronic musical instrument that includes, in addition to the at least one processor, a performance controller to perform the following: instructing sound generation of a first musical tone in response to a first operation on the performance controller; in response to a second operation on the performance controller during the sound generation of the first musical tone, obtaining a first amplitude value of the first musical tone at a time of the second operation, and obtaining a second amplitude value at which a second musical tone is to be sound-produced in response to the second operation on the performance controller; determining a parameter value for adjusting a decay rate of the first musical tone based on a ratio of the first amplitude value to the second amplitude value; and causing the first musical tone to decay based on the determined parameter value.

According to at least some of the aspects of the present invention, improvements are made to bring the musical sound generated by the electronic musical instrument during a rapid reiteration performance operation closer to a natural musical instrument.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a block diagram showing a configuration of an electronic musical instrument according to an embodiment of the present invention.

FIG. 2 is a diagram showing an example of the structure of waveform data stored in the ROM provided in the electronic musical instrument according to an embodiment of the present invention.

FIG. 3 is a block diagram showing a configuration of a sound source provided in the electronic musical instrument according to an embodiment of the present invention.

FIG. 4A is a diagram showing an example of a pitch envelope output from a pitch envelope generator provided in the sound source according to an embodiment of the present invention.

FIG. 4B is a diagram showing an example of a filter envelope output from a filter envelope generator provided in the sound source according to an embodiment of the present invention.

FIG. 4C is a diagram showing an example of an amplifier envelope output from an amplifier envelope generator provided in the sound source according to an embodiment of the present invention.

FIG. 5_{A} is a diagram illustrating the characteristics of musical sounds when an impact is applied to a vibrating body during vibration.

FIG. 5B is a diagram illustrating the characteristics of musical sounds when an impact is applied to a vibrating body during vibration.

FIG. 5C is a diagram illustrating the characteristics of musical sounds when an impact is applied to a vibrating body during vibration.

FIG. 6 is a flowchart of a key pressing process executed by a processor of an electronic musical instrument in one embodiment of the present invention.

FIG. 7 is a flowchart of part of the key pressing process executed by the processor of the electronic musical instrument in one embodiment of the present invention.

FIG. 8 is a graph showing the relationship between the amplitude value of the second musical tone corresponding to the second operation and the velocity value at the time of the second operation in one embodiment of the present invention.

FIG. 9 is a flowchart of the muting process executed by the processor of the electronic musical instrument in one embodiment of the present invention.

FIG. 10 is a graph showing the relationship between the parameter value for adjusting the decay rate of the first musical tone and the ratio of the first amplitude value and the second amplitude value in one embodiment of the present invention.

FIG. 11 describes the effect when the decay rate of the first musical tone is adjusted by executing the key pressing process of FIG. 7.

FIG. 12 describes the effect when the decay rate of the first musical tone is adjusted by executing the key pressing process of FIG. 7.

FIG. 13 describes the effect when the decay rate of the first musical tone is adjusted by executing the key pressing process of FIG. 7.

### DETAILED DESCRIPTION OF EMBODIMENTS

The electronic musical instrument according to embodiments of the present invention will be described in detail with reference to the drawings. The method and program according to the embodiments of the present invention are realized by causing a computer/processor (circuit component) of an electronic musical instrument to execute various processes.

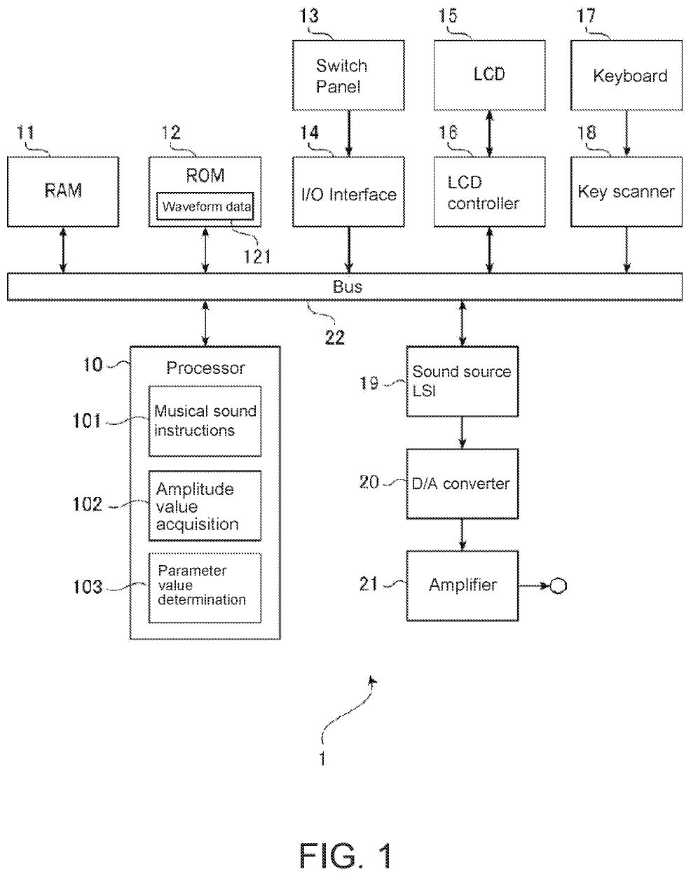

FIG. 1 is a block diagram showing the configuration of the electronic musical instrument 1. In the present embodiment, the electronic musical instrument 1 is, for example, an electronic piano, and is configured such that when a key with a single pitch is repeatedly hit, a natural musical sound (for example, a characteristic close to that of an acoustic musical instrument) can be produced and heard by adjusting the decay rate of the musical sound that has already been produced.

It should be noted that the technique of the present invention for producing a natural musical sound during the rapid reiteration operations can be applied to electronic musical instruments other than electronic pianos. Specifically, an acoustic instrument of a type that gives an impact to a vibrating body to generate a musical sound (for example, a percussion instrument, a plucked string instrument, a plucked string instrument, a chromatic percussion, etc.) may be configured as an electronic musical instrument within the scope of the present invention.

As shown in FIG. 1, the electronic instrument 1 includes, as hardware configurations, a processor 10, a RAM (Random Access Memory) 11, a ROM (Read Only Memory) 12, a switch panel 13, an input/output interface 14, an LCD (Liquid Crystal Display) 15, an LCD controller 16, a keyboard 17, a key scanner 18, a sound source LSI (Large Scale Integration) 19, a D/A converter 20, and an amplifier 21. These parts of the electronic musical instrument 1 are connected by a bus 22.

The processor 10 collectively controls the electronic musical instrument 1 by reading out the programs and data stored in the ROM 12 and using the RAM 11 as a work area.

The processor 10 is, for example, a single processor or a multiprocessor, and includes at least one processor. In the case of a configuration including a plurality of processors, the processor 10 may be packaged as a single device, or may be composed of a plurality of physically separated devices in the electronic musical instrument 1.

As a functional block, the processor 10 has a musical tone/sound instructions part 101 that instructs the sound generation of a first musical tone/sound in response to a first operation on a performance controller (performance elements), an amplitude value acquisition part 102 that obtains a first amplitude value of the first musical sound in response to a second operation on the performance controller that occurs during the sound generation of the first musical sound and that obtains a second amplitude value of a second sound to be produced in response to the second operation, and a parameter value determination part 103 that determines a parameter value for adjusting the decay rate of the first musical tone based on the ratio of the first amplitude value to the second amplitude value. The musical sound instruction part 101 instructs the attenuation of the sound generation of the first musical sound based on the parameter value determined by the parameter value determination part 103. Here, each functional block of the processor 10 shown in FIG. 1 may be realized by software, or may be partially or wholly realized by hardware such as a dedicated logic circuit.

In this specification, two consecutive key pressing operations are defined as a first operation and a second operation. “Two consecutive key pressing operations” means that the next key pressing operation was performed during the sound production of the sound responsive to the first key pressing operation. Therefore, the second operation means the operation that occurs next to the first operation, performed during the sound production corresponding to the first operation (during the sound production of the first musical sound). In the case of three consecutive key press operations (that is, when the next key press operation is performed while two musical tones corresponding to two consecutive key press operations are being sound-produced), the second key press operation becomes the first operation, and the third key pressing operation becomes the second operation.

RAM 11 temporarily holds data and programs. The RAM 11 holds programs and data read from the ROM 12 and other data necessary for communication.

The ROM 12 is a non-volatile semiconductor memory, such as a flash memory, an EPROM (Erasable Programmable ROM), and an EEPROM (Electrically Erasable Programmable ROM), and plays a role as a secondary storage device or an auxiliary storage device. For example, waveform data 121 is stored in the ROM 12. As an additional note, the ROM 12 stores programs and data used by the processor 10 to perform various processes, and data generated or acquired by the processor 10 performing various processes.

The switch panel 13 is an example of an input device. When the user operates the switch panel 13, a signal indicating the corresponding operation is output to the processor 10 via the input/output interface 14. The switch panel 13 may be, for example, a mechanical type, a capacitive contactless type, a membrane type or the like having key switches, buttons, or the like. The switch panel 13 may be a touch panel.

LCD15 is an example of a display device. The LCD 15 is driven by the LCD controller 16. When the LCD controller 16 drives the LCD 15 according to the control signal by the processor 10, the LCD 15 displays a screen corresponding to the control signal. The LCD 15 may be replaced with other types of display device, such as an organic EL (Electro Luminescence) or an LED (Light Emitting Diode). The LCD 15 may be a touch panel. In this case, the touch panel may serve as both an input device and a display device.

The keyboard 17 includes a keyboard having a plurality of white keys and a plurality of black keys as a plurality of performance elements. Each key is associated with a different pitch.

The key scanner 18 monitors the key press and release of the keyboard. When the key scanner 18 detects, for example, a key press operation by a user, the key scanner 18 outputs key press event information to the processor 10. The key press event information includes the pitch (key number) of the key related to the key press operation and its speed (velocity value). The velocity value can be said to be a value indicating the strength of the key press operation.

The processor 10 operates as a musical sound/tone instruction part 101 that instructs the sound generation of a musical tone in response to an operation (first operation or second operation) for a key (performance element). The sound source LSI 19 generates a musical tone based on the waveform data read from the ROM 12 under the instruction of the processor 10. In the present embodiment, the sound source LSI 19 can simultaneously produce 128 musical tones. In the present embodiment, the processor 10 and the sound source LSI 19 are configured as separate devices, but in another embodiment, the processor 10 and the sound source LSI 19 may be configured as one processor.

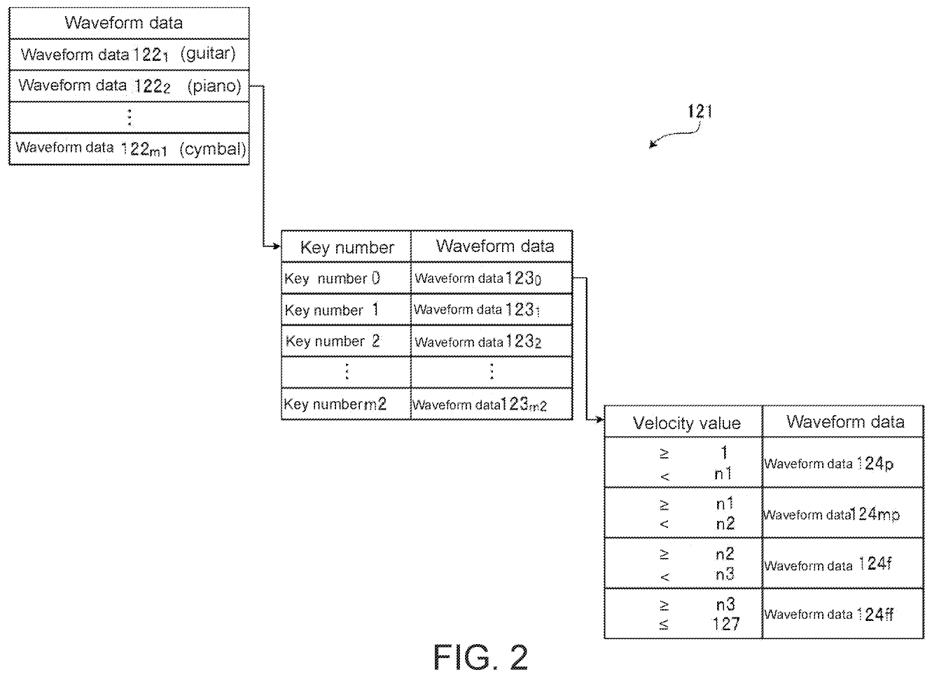

FIG. 2 is a diagram showing an example of the structure of the waveform data 121 stored in the ROM 12. As shown in FIG. 2, waveform data information 122₁ to 122ₘₗ of various tones such as “guitar” and “piano” are registered in the waveform data 121. In each of the waveform data information 122₁ to 122ₘ₁ of various tones, waveform data 123₀ to 123ₘ₂ are respectively registered to all key numbers for the target tone color (for example, piano). In more detail, for each key number, waveform data corresponding to a specified velocity value (that is, the strength of the operation on the performance element) is registered. For example, with 1<n₁ <n2<n3<127, for each key number, the waveform data 124p corresponding to a low velocity value (1 or more and less than n1), the waveform data 124mp corresponding to a slightly lower velocity value (n1 or more and less than n2), the waveform data 124f corresponding to a slightly high velocity value (n2 or more and less than n3), and waveform data 124ff corresponding to a high velocity value (n3 or more and 127 or less) are registered.

The processor 10 reads out the waveform data according to the strength of the operation (in other words, the velocity value) on the performance element from the plurality of waveform data stored in the ROM 12. More specifically, the processor 10 sets a musical tone (guitar, piano, etc.) according to the user's operation on the switch panel 13. The processor 10 reads out the waveform data corresponding to the key press event information (that is, the key number pressed and the velocity value at the time of key press) and the currently set tone color from the waveform data 121.

The musical sound signal generated by the sound source LSI 19 is amplified by the amplifier 21 after DA conversion by the D/A converter 20, and is output to a speaker (not shown).

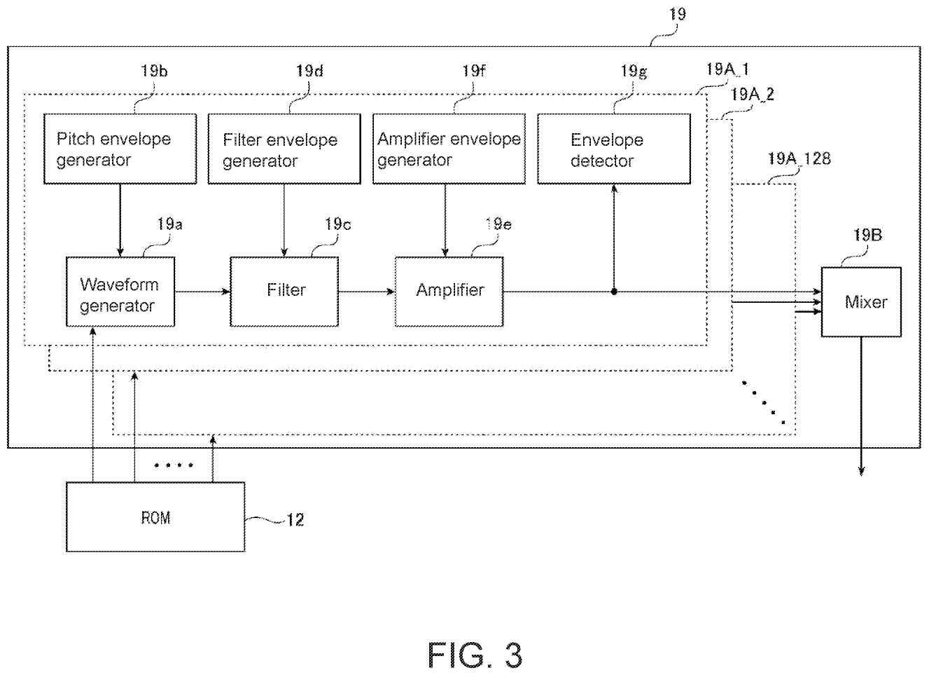

FIG. 3 is a block diagram showing a configuration of the sound source LSI 19. As shown in FIG. 3, the sound source LSI 19 includes 128 generator sections 19A_1 to 19A_128 and a mixer 19B. Generator sections 19A_1 to 19A_128 are provided corresponding to 128 simultaneous sound channels, respectively. The mixer 19B mixes the outputs of the generator sections 19A_1 to 19A_128 to generate a musical tone, and outputs the generated musical tone to the D/A converter 20. Each functional block of the sound source LSI 19 shown in FIG. 3 may be realized by software, or may be partially or wholly realized by hardware such as a dedicated logic circuit.

Each generator section 19A_1 to 19A_128 includes a waveform generator 19a, a pitch envelope generator 19b, a filter 19c, a filter envelope generator 19d, an amplifier 19e, an amplifier envelope generator 19f, and an envelope detector 19g.

The waveform generator 19a reads out the waveform data according to the instruction from the processor 10 from the ROM 12 at the pitch corresponding to the pitch envelope waveform output from the pitch envelope generator 19b.

The pitch envelope generator 19b applies temporal changes in the pitch when the waveform generator 19a reads out the waveform data from the ROM 12.

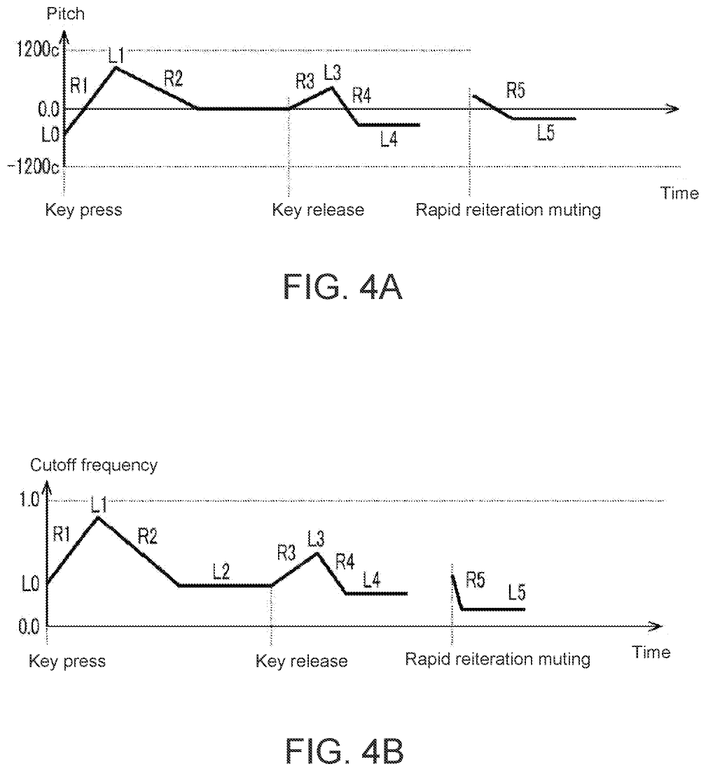

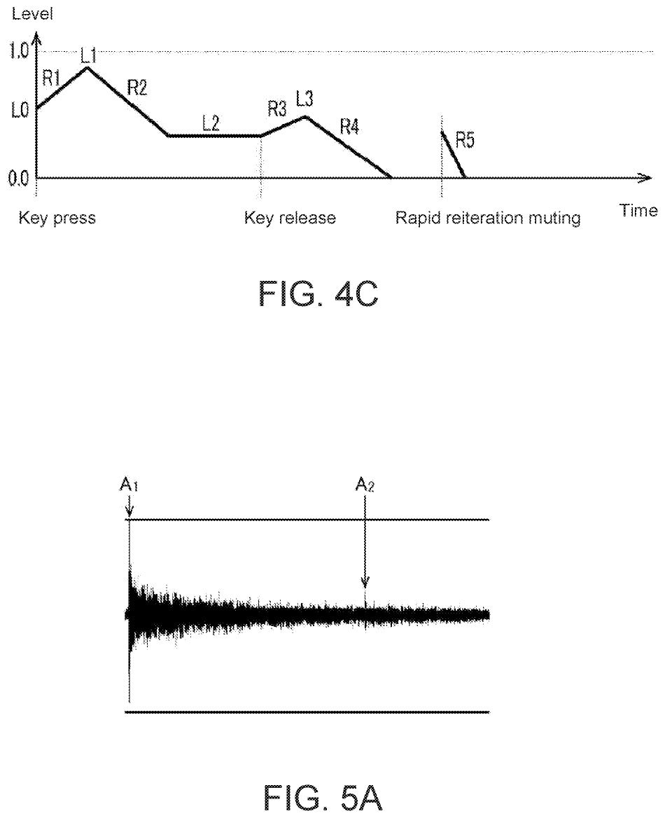

FIG. 4A shows an example of the pitch envelope output from the pitch envelope generator 19b. In FIG. 4A, the vertical axis indicates the pitch level and the horizontal axis indicates time. The variable range of pitch levels is −1200 cents to +1200 cents (−1 octave to +1 octave), and the level of this envelope is added to the played pitch.

The pitch envelope generator 19b outputs a pitch envelope according to the instruction by the processor 10 from among the three pitch envelopes respectively set for the key press event, the key release event, and the rapid reiteration event. The pitch envelope at the time of key pressing starts from level L0, reaches level L1 at speed R1, then descends at speed R2, and maintains a fixed level “0” which is a level when the key is continuously pressed. The pitch envelope at the time of key release reaches L3 at a speed R3 from the level at the time of key release, then descends at a speed R4, and finally maintains the level L4. The pitch envelope at the time of rapid reiteration muting stops the current note at the same time as the new note sound generation so that the pitch envelope goes to the level L5 at the speed R5.

The filter 19c changes the cutoff frequency according to the filter envelope output from the filter envelope generator 19d, and adjusts the frequency characteristics of the waveform data output from the waveform generator 19a.

The filter envelope generator 19d changes the cutoff frequency of the filter 19c over time.

FIG. 4B shows an example of the filter envelope output from the filter envelope generator 19d. In FIG. 4B, the vertical axis indicates the level of the cutoff frequency of the filter 19c, and the horizontal axis indicates time. The variable range of the cutoff frequency level is from a minimum value of 0 to a maximum value of 1.0.

The filter envelope generator 19d outputs a filter envelope according to the instruction by the processor 10 from among the three filter envelopes respectively set for the key press event, the key release event, and the rapid reiteration event. The filter envelope at the time of key pressing starts from level L0, reaches level L1 at speed R1, and then descends at speed R2 to maintain level L2. The filter envelope at the time of key release reaches L3 at a speed R3 from the level L2 at the time of key release, then descends at a speed R4, and finally maintains the level L4. The filter envelope at the time of the rapid reiteration muting stops the current note at the same time as the new note sound generation so that the filter envelope goes to the level L5 at the speed R5.

The amplifier 19e adjusts the volume of the waveform data output from the filter 19c by changing the amplification factor according to the amplifier envelope output from the amplifier envelope generator 19f.

The amplifier envelope generator 19f changes the amplification factor of the amplifier 19e over time.

FIG. 4C shows an example of the amplifier envelope output from the amplifier envelope generator 19f In FIG. 4C, the vertical axis indicates the level of the amplification factor of the amplifier 19e, and the horizontal axis indicates time. The variable range of the amplification factor level is from a minimum value of 0 to a maximum value of 1.0.

The amplifier envelope generator 19f outputs an amplifier envelope according to an instruction from the processor 10 from among three amplifier envelopes respectively set for the key press event, the key release event, and the rapid reiteration event. The amplifier envelope at the time of key pressing starts from level L0, reaches level L1 at speed R1, and then descends at speed R2 to maintain level L2. The amplifier envelope at the time of key release reaches L3 at a speed R3 from the level L2 at the time of key release, then descends at a speed R4, and finally maintains a fixed level “0”. The amplifier envelope at the time of the rapid reiteration muting stops the current note at the same time as the new note sound generation so that the envelope goes to the level “0” at the speed R5.

The envelope detector 19g detects the envelope of the waveform output from the amplifier 19e. For example, the envelope detector 19g detects the envelope (in other words, the amplitude value) of the waveform output from the amplifier 19e by converting the waveform output from the amplifier 19e into absolute values with a rectifying circuit, and by smoothing the absolute valued waveform with a low-pass filter.

Here, if the waveform level is normalized, the value of the amplifier envelope generator 19f may be applied as the envelope of the waveform output from the amplifier 19e. Even if the waveform level is not normalized, a virtual level envelope generator can be driven separately for each generator section, and the value obtained from the level envelope generator may be applied as the waveform envelope output from the amplifier 19e.

Here, in a percussion instrument, a plucked string instrument, a plucked string instrument, a chromatic percussion, etc., if the vibrating body of the musical instrument is in a stationary state, as long as the kinetic energy of an impacting body that gives an impact to the vibrating body is the same, almost the same musical sound is produced. On the other hand, when an impact is applied by the impacting body to the vibrating body that is vibrating, a part of the vibration energy of the vibrating body is radiated as an impact sound at the time of the impact. In other words, the vibration energy of the vibrating body is lost at the time of the impact. How much the vibration energy of the vibrating body is lost at the time of the impact depends on, for example, the relationship between the vibration energy of the vibrating body and the kinetic energy of the impacting body. Therefore, even if the kinetic energy of the impacting body is the same, the way in which the musical sound is generated after the impact changes depending on the vibration state of the vibrating body at the time of the impact.

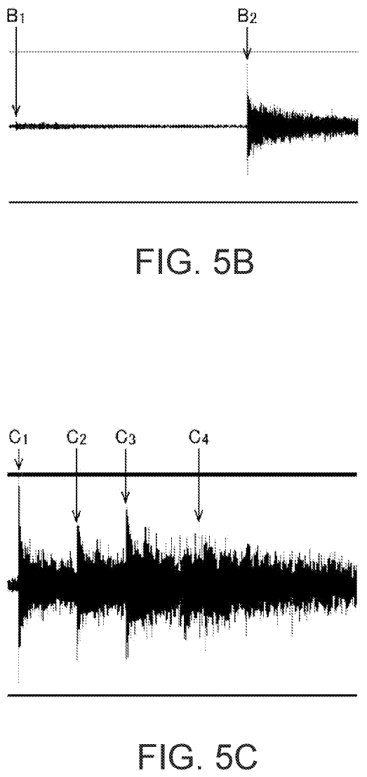

Here, taking a cymbal as an example, the characteristics of musical sounds when an impact is applied to a vibrating body that is vibrating will be explained. FIGS. 5A-5C each show the amplitude of a musical sound when a cymbal (vibrating body) is hit with a stick (impacting body). In each of FIGS. 5A to 5C, the vertical axis indicates the amplitude and the horizontal axis indicates the time.

FIG. 5_{A} shows a case (hereinafter referred to as “case A”) in which the cymbal is strongly hit with a stick at the time of A1 and then weakly hit immediately thereafter (at the time of A2). In case A, the vibration generated by the strong impact at the time of A1 continues to decay naturally with the passage of time. Therefore, after the time of A1, it seems that the musical tone generated by the vibration caused by the impact is gradually attenuated. Then, at the time of A2, it seems that the impact sound due to the light hit is generated separately from the musical sound due to the vibration. This is because the vibration energy generated by the impact at the time of A1 is hardly lost by the impact of the light hit at the time of A2. Therefore, the vibration generated by the impact at the time of A1 will continue to be substantially naturally attenuated with the passage of time even after the time of A2.

FIG. 5B shows a case (hereinafter referred to as “case B”) in which the cymbal is tapped weakly with a stick at the time of B1 and immediately thereafter (at the time of B2) is tapped strongly. In case B, even if the vibration generated by the light hit at the time of B1 remains at the time of B2, because the musical sound due to this vibration is considerably smaller than the impact sound due to the strong impact at the time of B2, the musical sound due to this vibration is hardly heard by being overwhelmed by the impact sound. Even if this vibration decays rapidly after the time B2, or even if it continues to decay naturally with the passage of time, the way the musical sound is heard after the time B2 does not change much.

FIG. 5C shows a case where the cymbal is hit with a stick at each time point of the reference numerals C1 to C4 with the same strength (hereinafter referred to as “case C”). In case C, the amplitude increases immediately after the impact at each time point, but immediately converges within a certain range. This is because the amplitude of the vibrating body (cymbal) is physically limited and the vibrating body does not store energy, and the energy emitted as an impact sound at the time of the impact becomes as large as the kinetic energy of the impacting body.

Consider a case where the musical sounds of cases A to C are produced using an electronic musical instrument (specifically, an electronic piano). For example, in the electronic musical instrument described in Patent Document 1, when the velocity at the time of the current key press is larger than the velocity at the time of the previous key press, the musical sound generated in the previous operation is attenuated twice as fast as usual, and otherwise it is attenuated at the normal speed. Therefore, for example, in case A where the velocity at the time of key pressing at the time of A2 is larger than the velocity at the time of key pressing at the time of A1, the vibration generated at the time of A1 is attenuated unnecessarily quickly after the time of A2, and the musical sound is unpleasant and unnatural. Further, for example, in case C where the velocity at the time of key pressing at the time of C2 is the same or smaller than the velocity at the time of key pressing at the time of C1, the vibration does not immediately converge within a certain range after each key pressing operation and the volume becomes unnaturally loud.

Therefore, in the present embodiment, a key pressing process described below is executed so that the musical sound generated during the rapid reiteration operation becomes closer to the natural musical tone.

In the key pressing process according to the present embodiment, the ratio of the amplitude value (first amplitude value a) of the vibrating body that is vibrating to which an impact is to be applied in the rapid reiteration operation and the strength of the key pressing this time (second amplitude value b) is obtained. Based on this, the decay rate of the first musical tone (more specifically, the change rate/speed of the pitch, timbre, and volume of the already generated musical tone when the rapid reiteration operation muting is performed) is adjusted. Generator sections 19A_1 to 19A_128 correspond to the vibrating body here. The amplitude value (first amplitude value a) of the vibrating body is detected by the envelope detector 19g in the generator section.

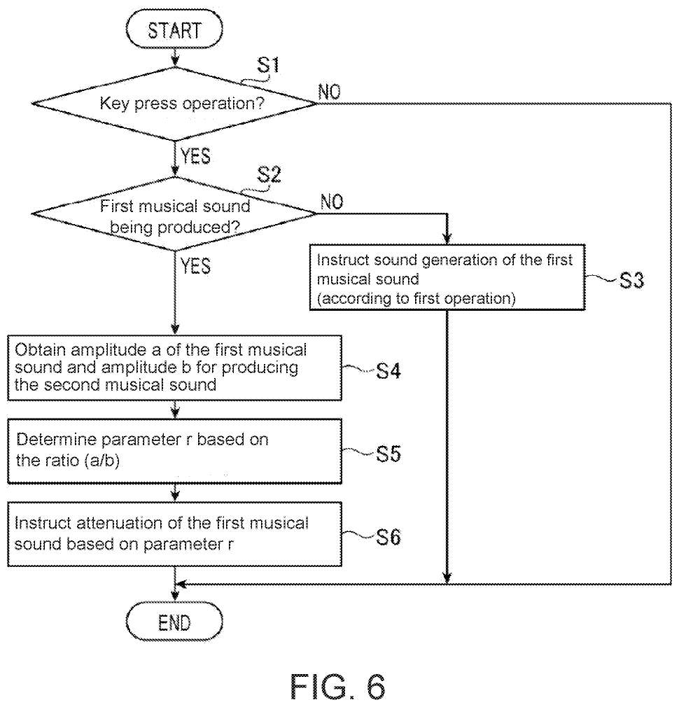

FIG. 6 is a flowchart of the key pressing process executed by the processor 10 in cooperation with respective parts of the electronic musical instrument 1. As shown in FIG. 6, the processor 10 determines whether or not a key press operation has been detected (step S1). When the key press event information indicating the key number and velocity value of the key related to the key press operation is input from the key scanner 18 to the processor 10, the key press operation is detected (step S1: YES).

When the key press operation is detected (step S1: YES), the processor 10 determines whether or not a musical tone (that is, the first musical tone) corresponding to a key number that is the same as the key number acquired in step S1 has been produced (step S2). When the first musical tone has not been produced (step S2: NO), the processor 10 instructs the sound source LSI 19 to generate sound according to the key press event information acquired in step S1 (in other words, the sound generation of the first musical tone now occurs) (step S3). That is, in step S3, the processor 10 operates as a musical tone (sound) instruction part 101 that instructs the sound generation of the first musical tone in response to the first operation on the key (performance element). By this sound generation instruction, the reading of the waveform data is started in the generator section, and the output of the envelope is started from each envelope generator.

If the first musical tone (sound) has been produced (step S2: YES), the processor 10 acquires the first amplitude value a of the first musical tone (sound) (that is, the amplitude value of the first musical tone at the time of the second operation), and acquires the second amplitude value b for the second musical tone to be produced in response to the second operation, which is the detected key operation (step S4). That is, in step S4, the processor 10 operates as the amplitude value acquisition part 102 that acquires the first amplitude value a of the first musical tone and the second amplitude value b for the second musical tone to be produced, in response to the second operation (of the same key as the first key operation) that is performed during the sound generation of the first musical tone.

The processor 10 determines the parameter value r based on the ratio of the first amplitude value a and the second amplitude value b acquired in step S4 (step S5), and instructs the sound source LSI 19 to attenuate the sound of the first musical tone in accordance with the thus determined parameter value r (step S6).

As will be described in detail later, the parameter value r is a parameter value for adjusting the decay rate of the first musical tone. As described above, in step S5, the processor 10 operates as the parameter value determination part 103 that determines the parameter value r for adjusting the decay rate of the first musical tone based on the ratio of the first amplitude value a and the second amplitude value b.

According to the instruction in step S6, the attenuation speed of the first musical tone is adjusted based on the parameter value r. This can prevent unnatural swelling of the volume and unnatural musical tone due to unnecessary fast attenuation during the rapid reiteration operation. As a result, it is possible to bring the produced musical sound during the rapid reiteration operations closer to the characteristics of a natural musical sound such as that of an acoustic musical instrument.

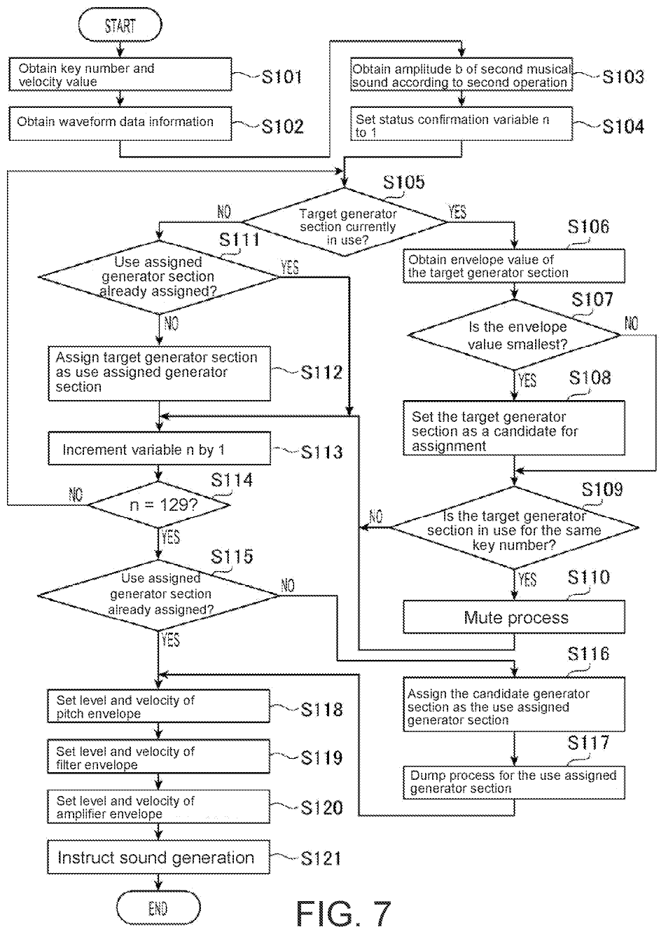

As described above, when the first musical tone corresponding to the previous key press operation is being produced at the time of the second operation, the processes of steps S4 to S6 in FIG. 6 are executed. By executing the processes of steps S4 to S6, the characteristics of the musical sound during the rapid reiteration operation can be brought closer to the characteristics of the natural musical sound. The details of the processes of steps S4 to S6 will be described with reference to the flowchart of FIG. 7.

As shown in FIG. 7, the processor 10 acquires the key number and velocity value included in the key press event information input from the key scanner 18 (step S101). For convenience, this velocity value is assigned a reference numeral v. The velocity value v ranges from a minimum value of 1 to a maximum value of 127.

The processor 10 obtains waveform data determined according to the currently set tone color (guitar, piano, etc.) and the key number and velocity value v acquired in step S101 from among the plurality of waveform data 121 stored in the ROM 12 (step S102).

The processor 10 acquires the second amplitude value b of the musical tone corresponding to the current key pressing operation by using the velocity value v indicating the speed of the current key pressing operation (from another viewpoint, the strength of the key pressing) (step S103). The second amplitude value b may also be described as “a second amplitude value for the second musical tone corresponding to the current key pressing operation (second operation)”. Here, as a specific example of acquiring the second amplitude value b, a method of calculating the second amplitude value b using the following equation (1) is shown.

b=(v/127)²×100 [Equation (1)]

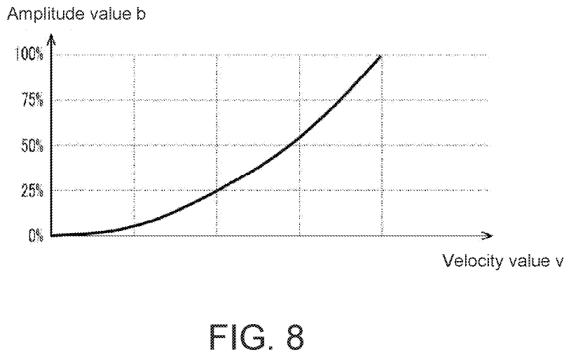

FIG. 8 is a graph showing the relationship between the second amplitude value b and the velocity value v calculated by the equation (1). In FIG. 8, the vertical axis indicates the second amplitude value b, and the horizontal axis indicates the velocity value v. As shown in FIG. 8, the second amplitude value b increases quadratically with the velocity value v. The second amplitude value b ranges from a minimum value of 0 to a maximum value of 100.

Numbers 1 to 128 are assigned to the generator sections 19A_1 to 19A_128, respectively. The processor 10 sets the variable n indicating the number of the generator section for which the status is to be confirmed to 1 (step S104). For convenience, the target generator section whose status is to be checked is referred to as “target generator section”.

The processor 10 checks the status of the target generator section to which the same number as the variable n is assigned (step S105). Specifically, the processor 10 checks whether the target generator section is currently in use to generate a musical tone.

If the target generator section is currently used to generate a musical tone (step S105: YES), the processor 10 acquires the value of the envelope detected by the envelope detector 19g of the target generator section (step S106). The acquired envelope value ranges from a minimum value of 0 to a maximum value of 100.

The processor 10 compares the value of each envelope that has been acquired in step S106 up to now after the start of the key pressing process of FIG. 7 with the value of the envelope acquired in step S106 at this time, and determines whether or not the value of the envelope acquired in step S106 of is the smallest value (step S107).

When the value of the envelope acquired in step S106 this time is the smallest value (step S107: YES), the processor 10 sets the target generator section as a candidate to be used for generating a musical tone corresponding to the current key press operation (step S108). For convenience, the generator section set as such a candidate is referred to as “assignment candidate generator section”. If the assignment candidate generator section is already set, the target generator section is overwritten as a new assignment candidate generator section. If the value of the envelope acquired in step S106 at this time is not the smallest value (step S107: NO), the processor 10 does not set the target generator section as the assignment candidate generator section.

The processor 10 determines whether or not the target generator section is in the process of generating a musical tone with the same key number as the key number acquired in step S101 (step S109). If a musical tone is being generated with the same key number (step S109: YES), the processor 10 executes the mute process of step S110 and then proceeds to step S213.

If the target generator section is in the process of generating a musical tone with the same key number as the key number acquired in step S101, the value of the envelope acquired in this step S106 indicates the current amplitude value of the musical tone that has been produced in response to the previous key press operation on the key number of the key that is pressed at this time. This amplitude value can also be described as “the first amplitude value a of the first musical tone corresponding to the first operation”.

As described above, in steps S103 and S106, the processor 10 operates as the amplitude value acquisition part 102 that acquires the first amplitude value a of the first musical tone and the second amplitude value b for the second musical tone to be produced according to the second operation in response to the second operation (an operation on the key having the same key number as the first operation) that occurs during the sound production of the first musical tone corresponding to the first operation on a performance element (a key of the keyboard 17 in this embodiment).

When the target generator section is in the process of generating a musical tone with a key number different from the key number acquired in step S101 (step S109: NO), the processor 10 proceeds to step S213 without executing the mute process of step S110.

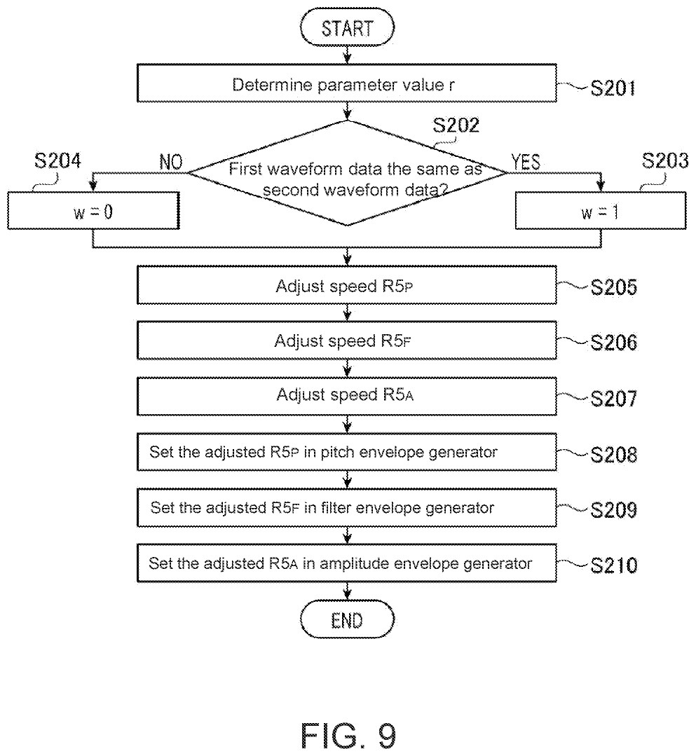

FIG. 9 is a flowchart of the mute process.

Considering the above-mentioned cases A to C, the closer the amplitude value of the musical tone generated in the previous operation (first amplitude value a) and the amplitude value of the musical tone generated in the current operation (second amplitude value b), the more likely an unnatural musical tone (musical tone whose volume is unnaturally swollen) will occur unless the first musical tone is attenuated quicker. Further, the greater the difference between the first amplitude value a and the second amplitude value b, the more likely the musical tone becomes unnatural if the first musical tone is attenuated faster.

Therefore, the processor 10 determines the parameter value r for adjusting the decay rate of the first musical tone based on the ratio (a/b) of the first amplitude value a and the second amplitude value b (step S201). More specifically, the processor 10 sets the parameter value to a value that increases the decay rate of the first musical tone as the ratio (a/b) is closer to 1. This way, in step S201, the processor 10 operates as the parameter value determination part 103 for determining the parameter value r.

Here, as a specific example of determining the parameter value r, a method of calculating the parameter value r using the following equation (2) is shown.

r=100/(1+|log2(a/b)|) [Equation (2)]

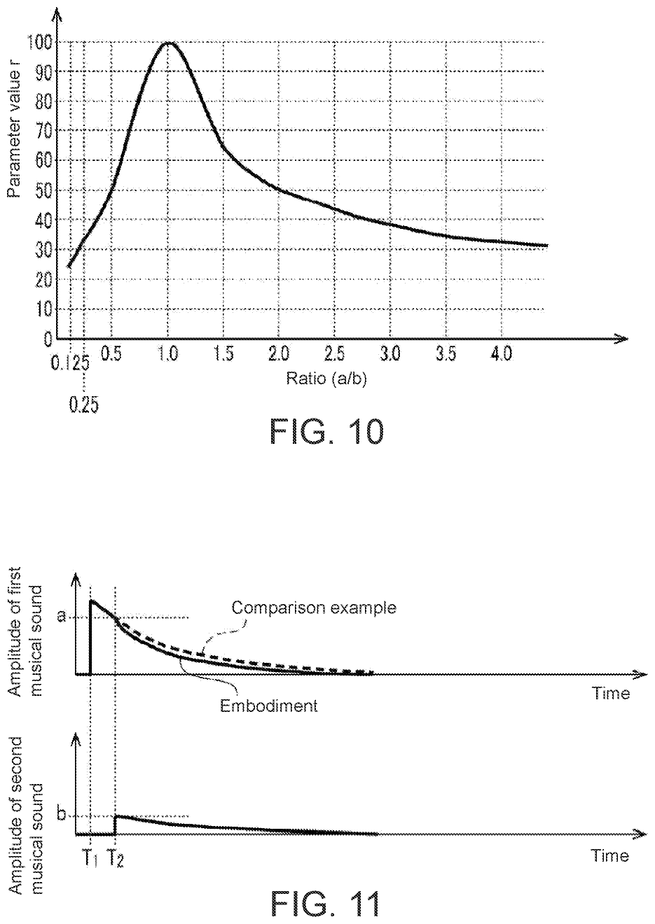

FIG. 10 is a graph showing the relationship between the parameter value r calculated by the equation (2) and the ratio (a/b). In FIG. 10, the vertical axis indicates the parameter value r, and the horizontal axis indicates the ratio (a/b). The parameter value r is greater than 0 and less than or equal to 100 (part of the graph is omitted in FIG. 10). As shown in FIG. 10, in general, the closer the ratio (a/b) is to 1, the larger the parameter value r becomes.

In the present embodiment, as described above, a method of switching the waveform data used for generating the musical tone according to the strength of the operation (in other words, the velocity value) with respect to the performance operator is adopted. This method is called, for example, a velocity split method. When the electronic musical instrument 1 adopting the velocity split method is repeatedly hit with the same strength as in case C above, the same waveform data is read out from the ROM 12. In this case, if the first musical tone generated by the previous key pressing operation remains at a loud volume, the first musical tone and the second musical tone generated by the current key pressing operation cause phase interference, causing an unnatural musical tone to be produced when the rapid reiteration operation is performed.

In the present embodiment, in order to suppress such phase interference, depending on whether or not the waveform data used for generating the first musical tone and the waveform data used for generating the second musical tone are the same, the way the first musical tone is attenuated is changed.

Specifically, the processor 10 determines whether or not the waveform data (first waveform data) that has been read in the target generator section and the waveform data (second waveform data) acquired in step S102 are the same (step S202). When both have the same waveform data (step S202: YES), the processor 10 sets the variable w to 1 (step S203), and then executes the processes of step S205 and thereafter. When the two are different waveform data (step S202: NO), the processor 10 sets the variable w to 0 (step S204), and then executes the processes of step S205 and thereafter.

The speed R5 of each envelope for the rapid reiteration muting indicates the decay rate of the first musical tone. In steps S205 to S207, the speed R5 of each envelope is adjusted using the parameter value r determined based on the ratio (a/b).

Specifically, in step S205, the processor 10 adjusts the speed R5 (hereinafter referred to as “speed R5_{P}”) of the pitch envelope as the rapid reiteration muting based on the parameter value r. Here, the speed R5_{P} is adjusted using the following equation (3). The speed R5_{P} ranges from a minimum value of 0 to a maximum value of 100. When the speed R5_{P} exceeds 100 in the following equation (3), the speed R5_{P} is clipped to 100.

R5_{P}=R5_{P0}+(PD_{P1}×r/100)+PD_{P2}×w

R5_{P0}: Speed R5_{P} before adjustment

PD_{P1}, PD_{P2}: Depths of adjustment of speed R5_{P} [Equation (3)]

The speed R5_{P0} is the speed R5_{P} before the adjustment process according to the equation (3), and ranges from a minimum value of 0 to a maximum value of 100. Here, in the present embodiment, the speed R5_{P} is adjusted by adding the value calculated based on the parameter value r to the speed R5_{P0} which is the original speed. Therefore, the speed R5_{P} after adjustment is higher than the speed R5_{P0} before adjustment. In the equation (3), the value of the speed R5_{P0} is set to 0, which is the smallest value in the configurable range, so that the range of the speed R5_{P} calculated by the equation (3) is 0 to 100.

The depth PD_{P1} and the depth PD_{P2} are the adjustment depths (degrees) of the speed R5_{P}, and each range from a minimum value of 0 to a maximum value of 100. The depth PD_{P1} and the depth PD_{P2} are preset to appropriate values for each musical tone (guitar, piano, etc.) and for each key number, for example. The values of the depth PD_{P1} and the depth PD_{P2} may be changed by a user operation on the switch panel 13.

In step S206, the processor 10 adjusts the speed R5 (hereinafter referred to as “speed R5_{F}”) of the filter envelope as the rapid reiteration muting based on the parameter value r. Here, the speed R5_{F} is adjusted using the following equation (4). The speed R5_{F} ranges from a minimum value of 0 to a maximum value of 100. When the speed R5_{F} exceeds 100 according to the following equation (4), the speed R5_{F} is clipped to 100.

R5_{F}=R5_{F0}+(FD_{P1}×r/100)+FD_{P2}×w

R5_{F0}: Speed R5_{F} before adjustment

FD_{P1}, FD_{P2}: Depths of adjustment of speed R5_{F} [Equation (4)]

The speed R5_{F0} is the speed R5_{F} before the adjustment process according to the equation (4), and ranges from a minimum value of 0 to a maximum value of 100. The value of the speed R5_{F0} is also set to 0 in the equation (4) for the same reason as for the speed R5_{P0}.

The depth FD_{P1} and the depth FD_{P2} are the adjustment depths (degrees) of the speed R5_{F}, and each range from a minimum value of 0 to a maximum value of 100. Similar to the depth PD_{P1}, the depth FD_{P1} and the depth FD_{P2} may be preset to appropriate values for each tone color and for each key number, or may be changed by a user operation.

In step S207, the processor 10 adjusts the speed R5 (hereinafter referred to as “speed R5A”) of the amplifier envelope as the rapid reiteration muting based on the parameter value r. Here, the speed R5_{A} is adjusted using the following equation (5). The speed R5_{A} ranges from a minimum value of 0 to a maximum value of 100. When the speed R5_{A} exceeds 100 according to the following equation (5), the speed R5_{A} is clipped to 100.

R5_{A}=R5_{A0}+(AD_{P1}×r/100)+AD_{P2}×w

R5_{A0}: Speed R5_{A} before adjustment

AD_{P1}, AD_{P2}: Depth of adjustment of speed R5_{A} [Equation (5)]

The speed R5_{A0} is the speed R5_{A} before the adjustment process according to the equation (5), and ranges from a minimum value of 0 to a maximum value of 100. The value of the speed R5_{A}, is also set to 0 in the equation (5) for the same reason as for the speed R5_{P0}.

The depth AD_{P1} and the depth AD_{P2} are the adjustment depths (degrees) of the speed R5_{A}, and each range from a minimum value of 0 to a maximum value of 100. Similar to the depth PD_{P1}, the depth AD_{P1} and the depth AD_{P2} may be preset to appropriate values for each tone color and for each key number, or may be changed by a user operation.

The terms (PD_{P2}×w, FD_{P2}×w, AD_{P2}×w) in Equations (3) to (5), respectively, take a value larger than 0 only when the waveform data (first waveform data) read out in the target generator section and the waveform data (second waveform data) acquired in step S102 are the same. That is, in order to suppress the phase interference between the first musical tone and the second musical tone, when the waveform data of both are the same, a faster decay rate is calculated by the equations (3) to (5). Therefore, when the first waveform data and the second waveform data are the same, the attenuation speed of the first musical tone is adjusted to a higher speed than when the waveform data of these tones are different. This makes it possible to avoid the generation of unnatural musical tones due to phase interference between the first musical tone and the second musical tone.

The processor 10 sets the speed R5_{P} of the first musical tone adjusted in step S205 in the pitch envelope generator 19b of the target generator section (step S208). As a result, the pitch envelope for the rapid reiteration muting (more specifically, the rate of change of the pitch for the rapid reiteration muting of the first musical tone) becomes a value adjusted by using the equation (3).

The processor 10 sets the speed R5_{F} of the first musical tone adjusted in step S206 to the filter envelope generator 19d of the target generator section (step S209). As a result, the filter envelope for the rapid reiteration muting (more specifically, the rate of change of the cutoff frequency for the rapid reiteration muting of the first musical tone) becomes a value adjusted by using the equation (4).

The processor 10 sets the speed R5_{A} of the first musical tone adjusted in step S207 to the amplifier envelope generator 19f of the target generator section (step S210). As a result, the amplifier envelope for the rapid reiteration muting (more specifically, the rate of change of the volume level for the rapid reiteration muting of the first musical tone) becomes a value adjusted by using the equation (5).

As described above, in steps S208 to S210, the processor 10 sets the decay rate of the first musical tone calculated in steps S205 to S207 in the target generator section. In other words, the processor 10 instructs the target generator section to attenuate the sound of the first musical tone based on the parameter value r determined in step S201. When the waveform data (first waveform data) read in the target generator section and the waveform data (second waveform data) acquired in step S102 are the same, the processor 10 specifies a faster speed as the decay rate of the first musical tone, as compared with the case where the waveform data of the first and second musical tones are different.

Returning to the explanation in FIG. 7, if the target generator section is not currently used to generate a musical tone (step S105: NO), the processor 10 determines whether or not a generator section for generating a musical tone corresponding to the current key press operation has already been assigned (step S111). For convenience, the one assigned as the generator section that generates the musical tone corresponding to the current key press operation is referred to as the “use assigned generator section”.

If the use assigned generator section is not assigned (step S111: NO), the processor 10 assigns the target generator section as the use assigned generator section (step S112), and proceeds to step S113. If the use assigned generator section has already been allocated (step S111: YES), the processor 10 proceeds to step S113 without executing step S112.

The processor 10 increments the variable n by 1 (step S113). The processor 10 determines whether or not the variable n after the increment is 129 (step S114). If the variable n is not 129 (step S114: NO), the processor 10 returns to step S105 and executes the processes of step S105 and thereafter on the updated target generator section that is specified by the incremented variable n.

If the interval between the rapid reiteration operation is short, there may be a situation in which multiple generator sections generate the musical tones of the same key number as the key number most recently pressed, albeit momentarily. In this case, the mute process of step S110 is executed for all the generator sections that generate the musical tones of the same key number.

When the variable n is 129 (step S114: YES), processing such as status confirmation has been completed for all 128 generator sections 19A_1 to 19A_128. Therefore, the processor 10 determines whether or not the use assigned generator section has been already allocated (step S115).

If the use assigned generator section has not been assigned (step S115: NO), the processor 10 assigns the candidate generator section that has been finally set in step S108 as the use assigned generator section (step S116), performs dump process on the use assigned generator section at the prescribed speed (for example, immediate dumping) (step S117), and proceeds to step S118. If the use assigned generator section has been assigned (step S115: YES), the processor 10 proceeds to step S118 without executing the allocation process of step S116 and the dump process of S117.

In order to change the pitch of the second musical tone with time, the processor 10 sets the levels L0, L1 and the speed R1 of the pitch envelope from the information acquired from the currently set timbre and key press event information (step S118).

In order to change the cutoff frequency for the second musical tone over time, the processor 10 sets the levels L0, L1 and the speed R1 of the filter envelope from the information acquired from the currently set timbre and key press event information. (Step S119).

In order to change the volume level of the second musical tone (in other words, the amplification factor of the amplifier 19e) over time, the processor 10 sets the levels L0, L1 and the speed R1 of the amplifier envelope from the information acquired from the currently set timbre and the key press event information (step S120).

The processor 10 issues a sound generation instruction to the use assigned generator section that has been set in the key pressing process of FIG. 7 to the sound source LSI 19 (step S121). By this sound generation instruction, the reading of the waveform data is started in the use assigned generator section, and the output of the envelope is started from each envelope generator, thereby completing the key pressing process of FIG. 7.

The effect of adjusting the decay rate of the first musical tone by executing the key pressing process of FIG. 7 will be described with reference to FIGS. 11 to 13.

FIG. 11 is a diagram illustrating case 1. Case 1 is a case where the key of the same key number as the first operation is weakly pressed when the first amplitude value a is large (in other words, the first amplitude value a is large and the second amplitude value b is small).

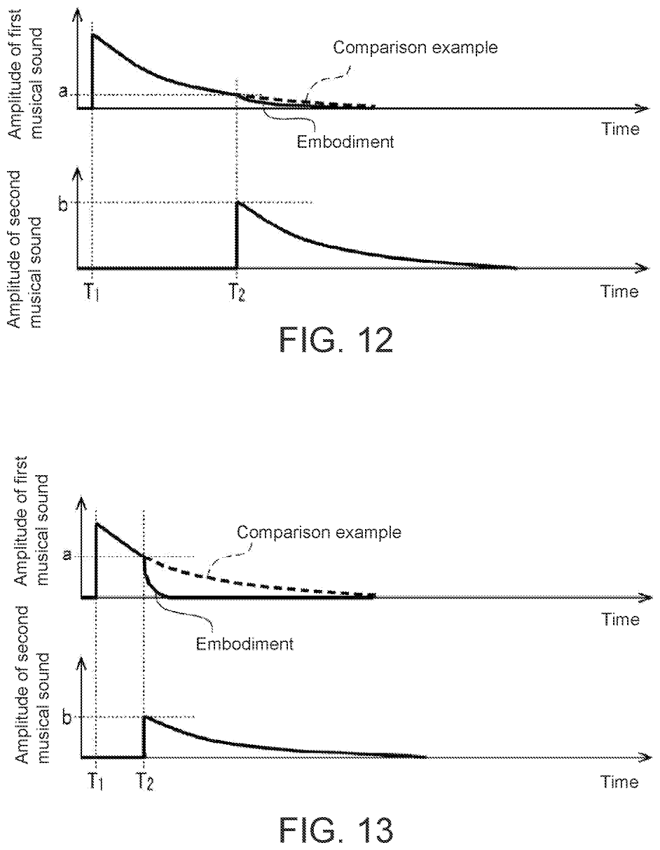

FIG. 12 is a diagram illustrating case 2. Case 2 is a case where the key of the same key number as the first operation is strongly pressed when the first amplitude value a is small (in other words, the first amplitude value a is small and the second amplitude value b is large).

FIG. 13 is a diagram illustrating the case 3. In case 3, the key of the same key number as the first operation is pressed at a medium strength when the first amplitude value a is medium (in other words, the first amplitude value a is medium and the second amplitude value b is also medium).

In each of FIGS. 11 to 13, the upper figure shows the amplitude value of the first musical tone, and the lower figure shows the amplitude value of the second musical tone. In each of FIGS. 11 to 13, the vertical axis represents the amplitude value and the horizontal axis represents time. The broken line in the upper figure shows the amplitude value of the first musical tone of a comparative example, and the solid line in the upper figure shows the amplitude value of the first musical tone of the embodiment. Reference numeral T1 indicates a time point when the first operation is performed, and reference numeral T2 indicates a time point when the second operation is performed. Each of FIGS. 11 to 13 is a schematic diagram showing that the amplitude instantly increases to the maximum value at the time of each operation and then gradually attenuates.

In each case, in order to compare the first musical tones of the comparative example and the embodiment, the second musical tone is the same in the comparative example and the embodiment. The first musical tone is the same in the comparative example and the embodiment except for the decay rate.

The first musical tone of the comparative example is the first musical tone when the attenuation speed (decay rate) is not adjusted based on the parameter value r (in other words, the first musical tone before adjusting the envelope), and is attenuated at a predetermined speed. The first musical tone of the embodiment is the first musical tone when the decay rate is adjusted based on the parameter value r by executing the key pressing process of FIG. 7 (in other words, the first musical tone after the envelope adjustment).

For example, in case 3, the decay rate of the first musical tone of the embodiment is significantly greater than that of the comparative example. When the rapid reiteration operation is performed with the same strength (in other words, when the ratio (a/b) is close to 1) as in case 3, the decay rate of the first musical tone is significantly reduced by executing the key pressing process in FIG. 7, and therefore, it is possible to prevent the volume from unnaturally swelling immediately after each key press operation.

In cases 1 and 2, the decay rate of the first musical tone does not change much between the comparative example and the embodiment. When the ratio (a/b) of the first amplitude value a and the second amplitude value b is not close to 1 as in these cases, the decay rate of the first musical tone is not made large due to the execution of the key pressing process in FIG. 7, and it is possible to prevent the musical sound from becoming unnatural due to unnecessarily fast attenuation.

As described above, in the present embodiment, the parameter value r is calculated based on the ratio (a/b) of the first amplitude value a of the vibrating body that is currently vibrating to the second amplitude value b for the second musical tone to be produced in response to the current key press operation each time, and using the calculated parameter value r, the first musical tone is attenuated (the closer the ratio (a/b) is to 1, the faster the first musical tone is attenuated). Therefore, the characteristics of natural musical tones such as acoustic instruments can be realized.

The present invention is not limited to the above-described embodiment, and can be modified at the implementation stage without departing from the gist thereof. The functions executed in the above-described embodiment may be combined as appropriate as possible. The embodiments described above include various stages, and various inventions can be extracted by an appropriate combination according to a plurality of disclosed constituent requirements. For example, even if some constituent elements are deleted from the constituent elements shown in the embodiment, if the same or similar effect can be obtained, the configuration in which the constituent elements are deleted can be regarded as an invention.

In the above embodiment, the change speed for the rapid reiteration muting is adjusted based on the parameter value r for all of the pitch, timbre, and volume of the first musical tone, but the present invention is not limited to this. Even when the change speed for the rapid reiteration muting is adjusted based on the parameter value r for one or two of the pitch, timbre, and volume of the first musical tone, the effect of approaching the characteristics of a natural musical tone can be obtained to some appropriate degree.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. An electronic musical instrument, comprising:
a performance controller; and
at least one processor, configured to perform the following:
instructing sound generation of a first musical tone in response to a first operation on the performance controller;
in response to a second operation on the performance controller during the sound generation of the first musical tone, obtaining a first amplitude value of the first musical tone at a time of the second operation, and obtaining a second amplitude value at which a second musical tone is to be sound-produced in response to the second operation on the performance controller;
determining a parameter value for adjusting a decay rate of the first musical tone based on a ratio of the first amplitude value to the second amplitude value; and
causing the first musical tone to decay based on the determined parameter value.

2. The electronic musical instrument according to claim 1, wherein the parameter value is determined such that the closer the ratio of the first amplitude value to the second amplitude value is to 1, the faster the first musical tone decays.

3. The electronic musical instrument according to claim 1, wherein the parameter value is determined by the following equation:
parameter value=100/(1+|log2 (a/b)|),
where a is the first amplitude value, and b is the second amplitude value.

4. The electronic musical instrument according to claim 1,
wherein in response to each operation on the performance controller, the at least one processor reads out waveform data that corresponds to a strength of the operation from a plurality of waveform data in a memory, and
wherein the at least one processor causes the first musical tone to decay faster when a first waveform data read out in response to the first operation is the same as a second waveform data read out in response to the second operation than when the first waveform data is different from the second waveform data.

5. The electronic musical instrument according to claim 1, wherein the at least one processor adjusts the decay rate based on the parameter value with respect to at least one of a pitch, timbre, and volume of the first musical tone.

6. The electronic musical instrument according to claim 1, further comprising a keyboard that includes the performance controller,
wherein the first and second operations are key press operations on the keyboard.

7. A method executed by at least one processor in an electronic musical instrument that includes, in addition to the at least one processor, a performance controller, the method comprising, via the at least one processor:
instructing sound generation of a first musical tone in response to a first operation on the performance controller;
in response to a second operation on the performance controller during the sound generation of the first musical tone, obtaining a first amplitude value of the first musical tone at a time of the second operation, and obtaining a second amplitude value at which a second musical tone is to be sound-produced in response to the second operation on the performance controller;
determining a parameter value for adjusting a decay rate of the first musical tone based on a ratio of the first amplitude value to the second amplitude value; and
causing the first musical tone to decay based on the determined parameter value.

8. The method according to claim 7, wherein the parameter value is determined such that the closer the ratio of the first amplitude value to the second amplitude value is to 1, the faster the first musical tone decays.

9. The method according to claim 7, wherein the parameter value is determined by the following equation:
parameter value=100/(1+|log2 (a/b)|),
where a is the first amplitude value, and b is the second amplitude value.

10. The method according to claim 7,
wherein in response to each operation on the performance controller, waveform data that corresponds to a strength of the operation is read out from a plurality of waveform data in a memory, and
wherein the first musical tone is caused to decay faster when a first waveform data read out in response to the first operation is the same as a second waveform data read out in response to the second operation than when the first waveform data is different from the second waveform data.

11. The method according to claim 7, wherein the decay rate is adjusted based on the parameter value with respect to at least one of a pitch, timbre, and volume of the first musical tone.

12. The method according to claim 7, wherein the first and second operations are key press operations on a keyboard included in the electronic musical instrument.

13. A computer readable non-transitory storage medium storing therein instructions, the instructions causing at least one processor in an electronic musical instrument that includes, in addition to the at least one processor, a performance controller to perform the following:
instructing sound generation of a first musical tone in response to a first operation on the performance controller;
in response to a second operation on the performance controller during the sound generation of the first musical tone, obtaining a first amplitude value of the first musical tone at a time of the second operation, and obtaining a second amplitude value at which a second musical tone is to be sound-produced in response to the second operation on the performance controller;
determining a parameter value for adjusting a decay rate of the first musical tone based on a ratio of the first amplitude value to the second amplitude value; and
causing the first musical tone to decay based on the determined parameter value.
